(19) United States
(12) Patent Application Publication
(10) Pub. No.: US 2012/0316895 A1
(43) Pub. Date: Dec. 13, 2012

(54) Generating Cross-Channel Medical Data

(75) Inventors: Mike West, Philadelphia, PA (US); Ali Hussam, Columbia, MO (US)

(73) Assignee: Universal Research Solutions LLC

(21) Appl. No.: 13/159,155

(22) Filed: Jun. 13, 2011

(51) Int. Cl. G06Q 50/00; G06Q 10/00

(52) U.S. Cl. 705/3

(57) ABSTRACT

A computer-implemented includes receiving, by one or more computers through one or more contributing channels, a plurality of items of medical data; generating, for the received medical data, one or more tags comprising metadata indicative of one or more attributes of the received medical data; and generating, at least partly based on the one or more tags, a correlation between at least a first item of medical data from the plurality and a second, different item of medical data from the plurality.

### BACKGROUND

An electronic medical record (“EMR”) is a computerized medical record created in an organization that delivers care, such as a hospital and/or a doctor's office. EMRs may be a part of a local stand-alone health data system that allows storage, retrieval and modification of records.

### SUMMARY

In one aspect of the present disclosure, a computer-implemented method includes receiving, by one or more computers through one or more contributing channels, a plurality of items of medical data; generating, for the received medical data, one or more tags comprising metadata indicative of one or more attributes of the received medical data; and generating, at least partly based on the one or more tags, a correlation between at least a first item of medical data from the plurality and a second, different item of medical data from the plurality.

Implementations of the disclosure may include one or more of the following features. In some implementations, the method also includes comparing a first value of a first attribute for the first item of medical data to a second value of a second attribute for the second item of medical data; and determining, based on comparing, a correspondence between the first value and the second value. In other implementations, the correlation includes at least metadata indicative of one or more of (i) the first value of the first attribute, or (ii) the second value of the second attribute.

In still other implementations, the method includes receiving a request for cross-channel medical data received from numerous, different contributing channels; parsing the request to determine one or more requested attributes for the cross-channel medical data; comparing attributes included in the tagged medical data to the one or more requested attributes; identifying, based on comparing, the first item of medical data and the second item of medical data as comprising attributes matching the requested attributes; and generating, using the identified first item of medical data and the identified second item of medical data, the cross-channel medical data. In some implementations, the method includes receiving a request for cross-channel medical data received from numerous, different contributing channels; parsing the request to determine one or more attributes of the cross-channel medical data; identifying a correspondence between (i) at least one of the one or more requested attributes, and (ii) metadata associated with the correlation; and generating, at least partly based on the first item of medical data and the second item of medical data, the cross-channel medical data. In yet other implementations, the method includes generating a graphical user interface that when rendered on a display device renders a visual representation of the cross-channel medical data.

In another aspect of the disclosure, one or more machine-readable media are configured to store instructions that are executable by one or more processing devices to perform operations including receiving, through one or more contributing channels, a plurality of items of medical data; generating, for the received medical data, one or more tags comprising metadata indicative of one or more attributes of the received medical data; and generating, at least partly based on the one or more tags, a correlation between at least a first item of medical data from the plurality and a second, different item of medical data from the plurality. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: receiving, through one or more contributing channels, a plurality of items of medical data; generating, for the received medical data, one or more tags comprising metadata indicative of one or more attributes of the received medical data; and generating, at least partly based on the one or more tags, a correlation between at least a first item of medical data from the plurality and a second, different item of medical data from the plurality. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a conceptual diagram of a system for generating cross-channel medical data.

FIG. 2 is a block diagram of components of the system for generating cross-channel medical data.

FIG. 3 is a flow chart of correlating medical data received from contributing channels.

FIG. 4 is a flow chart of a process for generating cross-channel data. Like reference symbols in the various drawings indicate like elements.

### DETAILED DESCRIPTION

Described herein is a system for collecting medical data from numerous, different data sources, entities and/or channels that contribute medical data to the system. These numerous, different data sources, entities and/or channels are collectively referred to herein as “contributing channels,” without limitation, for purposes of convenience. In an exemplary embodiment described herein, the system is configured to associate the collected medical data with metadata specifying attributes of the collected medical data. Generally, metadata includes data about another item of data, including, e.g., attributes, characteristics and/or qualities of the item of data (collectively referred to herein as “attributes,” without limitation, for purposes of convenience).

In an example, metadata may specify the name of a patient for which a medical procedure was performed, a name of a medical center in which the medical procedure was performed, a date on which the medical procedure was performed, a name of the medical procedure that was performed, and so forth. In this example, the metadata is encapsulated in a “tag.” Generally, a tag includes a data container in which data is stored in accordance with a pre-defined standard. The process of associating data with a tag is commonly referred to as “tagging.” In this example, the collected medical data is tagged such that medical data associated with same and/or similar metadata, but received from different contributing channels, may be analyzed, correlated and/or collated together. In the examples described herein, tags may include “semantic tags” that provide meaning to the tagged data.

In a particular exemplary embodiment, contributing channels may include, but are not limited to, the medical outcome system described in U.S. Ser. No. 12/699,522, the entire contents of which are incorporated herein by reference, a system for grading health care procedures and medical doctors (“health grades system”), an electronic health record (“EHR”) system, a billing system, and so forth.

In an example, the system is configured to use the tagged medical data to generate correlations among the medical data collected from different, contributing channels. In a particular exemplary embodiment, a correlation includes a qualitative correspondence between two items of data. Generally, a correspondence includes a similarity and/or equivalence between two items of data.

In this example, the system receives numerous, different types of medical data, including at least health grades data, outcome data, EHR data, and billing data. Health grades data includes medical data received from a health grades system. Health grades data may include data indicative of a patient's experience with the medical procedure, including, e.g., the patient's rating of the physician that performed the medical procedure, the patient's satisfaction with the medical procedure, and so forth. Outcome data includes medical data received from the medical outcome system. Outcome data may include data indicative of an outcome of the medical procedure, e.g., data specifying whether the medical procedure was successful. EHR data includes medical data received from the EHR system and may include data indicative of a medical record of the patient for which the medical procedure was performed. Billing data includes medical data received from the billing system and may include data indicative of the cost of the medical procedure.

In this example, the health grades data, the outcome data, the EHR data, and the billing data are each tagged with metadata associating the data with a particular medical procedure, in addition to other data that may be specific to the type of data being tagged. In an example, the data is semantically tagged, including, e.g., color coding the data to provide for enhanced visual reporting. In this example, data associated with a similar medical procedure, patient, geographic location is associated with a same and/or similar color to color code the data. The system is configured to analyze the metadata included in the tags. In an example, the system is configured to filter the metadata according to a pre-defined criteria. In this example, the pre-defined criteria may include a pre-defined value for a particular attribute, including, e.g., a particular value for an attribute indicative of a medical procedure name.

In a particular exemplary embodiment, based on filtering of the tags, the system detects that the health grades data, the outcome data, the EHR data, and the billing data pertain to the same medical procedure, e.g., because tags for these items of data each include metadata specifying the same medical procedure name. The system generates a correlation among the health grades data, the outcome data, the EHR data, and the billing data. In this example, the system generates a correlation through a pointer that links the health grades data, the outcome data, the EHR data, and the billing data together, e.g., in a database of the system. Generally, a pointer includes a data structure that causes one item of data to reference another item of data. By correlating together the data, the system generates cross-channel medical data pertaining to the particular medical procedure. Generally, cross-channel medical data includes medical data received from different contributing channels that relates to a pre-defined criteria and/or attribute of medical data.

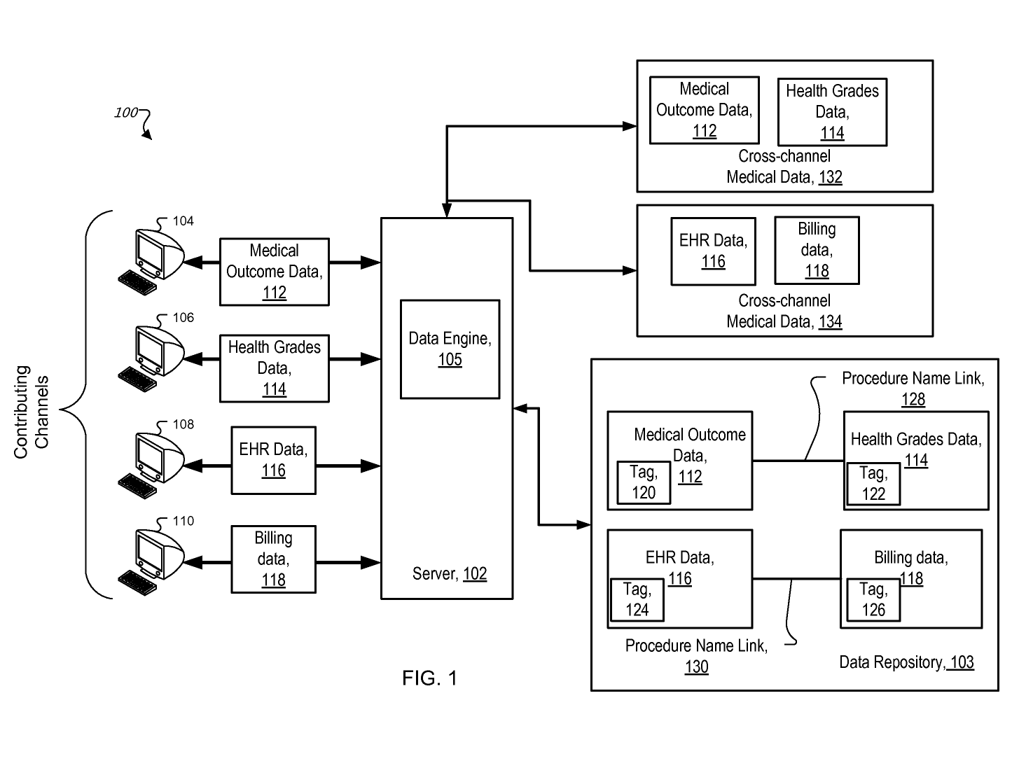

FIG. 1 illustrates a particular exemplary embodiment describe herein. In particular, FIG. 1 is a conceptual diagram of system 100 for generating cross-channel medical data 132, 134. In the exemplary embodiment of FIG. 1, system 100 includes server 102 and client devices 104, 106, 108, 110. Client device 104 includes a computing device that is configured to run the medical outcome system. Client device 106 includes a computing device that is configured to run the health grades system. Client device 108 includes a computing device that is configured to run the EHR system. Client device 110 includes a computing device that is configured to run the billing system.

In the exemplary embodiment of FIG. 1, client device 104 sends to server 102 medical outcome data 112. Client device 106 sends to server 102 health grades data 114. Client device 108 sends to server 102 EHR data 116. Client device 110 sends to server 102 billing data 118.

In the illustrative example of FIG. 1, server 102 includes data engine 105 that is configured to process received data 112, 114, 116, 118. In this example, data engine 105 analyzes received data 112, 114, 116, 118 to tag received data 112, 114, 116, 118. Received data 112, 114, 116, 118 includes data indicative of attributes of the data, including, e.g., a name of the contributing channel from which the data was sent, a patient name associated with the data, a medical procedure associated with the data, a medical facility associated with the data, a cost of the medical procedure, and so forth.

In an example, data engine 105 is configured to tag received data 112, 114, 116, 118 with metadata specifying attributes of received data 112, 114, 116, 118. The attributes of received data 112, 114, 116, 118 may include, e.g., a medical procedure name attribute, a medical facility name attribute, a receiving channel name attribute, a patient name attribute, a medical outcome attribute, a health grade attribute, and so forth.

In another example, the attributes may also include data specific to the contributing channel that sent the data to server 102. For example, medical outcome data 112 may include an attribute (“a medical outcome attribute”) specifying the outcome of a medical procedure. Health grades data 114 may include an attribute (“a health grade attribute”) specifying a health grade for a medical procedure. EHR data 116 may include an attribute (“an EHR attribute”) specifying data included in a health record of a patient. Billing data 118 may include an attribute (“a billing attribute”) specifying a cost of a medical procedure, and/or any other data pertaining to billing and/or cost of a medical procedure.

Data engine 105 is configured to use attributes in received data 112, 114, 116, 118 to generate tags 120, 122, 124, 126, in accordance with the format specified in the below Table 1:

TABLE 1

Name of attribute = “metadata for attribute”

In a particular example, received data 112, 114, 116, 118 pertains to various medical procedures that were performed on various patients at a particular medical facility named “Mount Vernon Hospital.” In this particular example, medical outcome data 112 is tagged with tag 120, the contents of which are illustrated in the below Table 2:

TABLE 2

medical procedure name attribute = “Knee Surgery”
medical facility name attribute = “Mount Vernon Hospital”
contributing channel name attribute = “Medical Outcome System”
patient name attribute = “Joe Johns”
health outcome attribute = “Success”

In the exemplary embodiment of Table 2, medical outcome data 112 pertains to medical data for a knee surgery performed on a patient named Joe Johns at Mount Vernon Hospital. Additionally, as indicated by a value of the health outcome attribute, the knee surgery was a success.

In another exemplary embodiment, health grades data 114 is tagged with tag 122, the contents of which are illustrated in the below Table 3:

TABLE 3

medical procedure name attribute = “Knee Surgery”
medical facility name attribute = “Mount Vernon Hospital”
contributing channel name attribute = “Health Grades System”
patient name attribute = “Joe Johns”
health grades attribute = “A+ for Mount Vernon Hospital ”

In the exemplary embodiment of Table 3, health grades data 114 pertains to medical data for the same knee surgery (included in medical outcome data 112) that was performed on Joe Johns at Mount Vernon Hospital. Additionally, as indicated by the “A+” value of the health grades attribute, Joe Johns graded Mount Vernon Hospital as providing a very high level of service and care.

In another exemplary embodiment, EHR data 116 is tagged with tag 124, the contents of which are illustrated in the below Table 4:

TABLE 4
medical procedure name attribute = “Heart Surgery”
medical facility name attribute = “Mount Vernon Hospital”
contributing channel name attribute = “EHR System”
patient name attribute = “Winston Madison”
EHR attribute = “patient previously had a stroke and open heart surgery
on January 1, 2011”

In the exemplary embodiment of Table 4, EHR data 116 pertains to medical data for a heart surgery performed on a patient named Winston Madison at Mount Vernon Hospital. Additionally, as indicated by a value of the EHR attribute, Winston Madison “previously had a stroke and open heart surgery on Jan. 1, 2011.”

In still another exemplary embodiment, billing data 118 is tagged with tag 126, the contents of which are illustrated in the below Table 5.

TABLE 5

medical procedure name attribute = “Heart Surgery”
medical facility name attribute = “Mount Vernon Hospital”
contributing channel name attribute = “Billing System”
patient name attribute = “Winston Madison”
billing attribute = “$2500”

In the exemplary embodiment of Table 5, billing data 118 pertains to medical data for the same heart surgery (included in EHR data 116) that was performed on Winston Madison at Mount Vernon Hospital. Additionally, as indicated by the “$2500” value of the billing attribute, the heart surgery cost $2500.

In this example, data engine 105 is configured to analyze tags 120, 122, 124, 126 and to generate correlations 128, 130 among medical outcome data 112, health grades data 114, EHR data 116, billing data 118, e.g., based on a sameness and/or a similarity and/or correspondence among the metadata included in tags 120, 122, 124, 126. As illustrated in the foregoing Tables 2-5, medical outcome data 112 and health grades data 114 both pertain to the same medical procedure (“knee surgery”) that was performed on a same patient (“Joe Johns”) at a particular medical facility (“Mount Vernon Hospital”). EHR data 116 and billing data 118 both pertain to another medical procedure (“heart surgery”) that was performed on another patient (“Winston Madison”) at the same medical facility (“Mount Vernon Hospital”).

In an exemplary embodiment described herein, data engine 105 generates correlations 128, 130 based on a sameness and/or a similarity of values for a particular attribute. In the illustrative example of FIG. 1, data engine 105 is configured to generate correlations 128, 130 among data associated with the same values for the medical procedure name attribute. Data engine 105 analyzes the values of the medical procedure name attribute in tags 120, 122, 124, 126. In this example, based on the filtering, data engine 105 determines that medical outcome data 112 and health grades data 114 have the same values for the medical procedure name attribute, namely, a value of “knee surgery.” Data engine 105 generates procedure name link 128 (also interchangeably referred to herein as correlation 128, without distinction) between medical outcome data 112 and health grades data 114.

In this example, cross-channel medical data 132 is generated through the correlation between medical outcome data 112 and health grades data 114 via link 128. Additionally, based on the filtering, data engine 105 determines that EHR data 116 and billing data 118 have the same values for the medical procedure name attribute, namely, a value of “heart surgery.” Accordingly, data engine 105 generates procedure name link 130 (also interchangeably referred to herein as correlation 130, without distinction) between EHR data 116 and billing data 118. In this example, cross-channel medical data 134 is generated through the correlation between EHR data 116 and billing data 118 via link 130.

In the illustrative example of FIG. 1, links 128, 130 include data indicative of the criteria used in generating links 128, 130. In this example, links 128, 130 include the values for the medical procedure name attribute. Accordingly, link 128 includes the metadata of “medical procedure name attribute=knee surgery.” Link 130 includes the metadata of “medical procedure name attribute=heart surgery.”

In another example, data engine 105 receives data indicative of knee surgeries that were performed at Mount Vernon hospital on numerous, different patients, including, e.g., Joe Johns. In this example, data engine 105 generates links between each item of data pertaining to knee surgery at Mount Vernon hospital. By doing so, data engine 105 may generate data indicative of an average number of knee surgeries performed at Mount Vernon hospital that are successful (e.g., based on medical outcome data), an average cost of knee surgeries performed at Mount Vernon hospital (e.g., based on billing data), average patient satisfaction for knee surgeries performed at Mount Vernon hospital (e.g., based on health grades data), similarities between patients on which knee surgery was performed at Mount Vernon hospital (e.g., based on EHR data), and so forth.

In the illustrative example of FIG. 1, data engine 105 receives a request (not shown) from a computing device used by a data consumer (not shown) for cross-channel medical data pertaining to a particular medical procedure. Generally, a data consumer includes an entity that receives and/or reviews data. Data consumers may include, for example, entities that generate integrated medical report cards (i.e., reports including data indicative of a comprehensive assessment of a medical procedure, medical facility, and so forth). Data consumers may also include insurance companies, an accountable care organization (“ACO”), an entity that generates and/or publishes research and publications, a collaborative group (e.g., a research group), and so forth.

In the illustrative example of FIG. 1, data engine 105 receives from a data consumer a request for data pertaining to certain search criteria, namely, knee surgeries that have been performed at Mount Vernon hospital. Data engine 105 compares the contents of the search criteria to the metadata included in links 128, 130. As previously described, link 128 includes the metadata of “medical procedure name attribute=knee surgery.” Link 130 includes the metadata of “medical procedure name attribute=heart surgery.” Using the metadata included in links 128, 130, data engine 105 identifies medical outcome data 112 and health grades data 114 as including medical data pertaining to knee surgeries. Data engine 105 then parses the contents of tags 120, 122 to determine that medical outcome data 112 and health grades data 114 also pertain to Mount Vernon hospital. Using link 128, data engine 105 determines that medical outcome data 112 and health grades data 114 pertain to knee surgeries that have been performed at Mount Vernon hospital.

Based on identification of medical outcome data 112 and health grades data 114 as being relevant to the search criteria, data engine 105 generates cross-channel medical data 132. In the illustrative example of FIG. 1, cross-channel medical data 132 includes medical outcome data 112 and health grades data 114. In an example, cross-channel medical data 132 includes a graphical user interface that renders a visual representation of the contents of medical outcome data 112 and health grades data 114.

In another example, data engine 105 is configured to identify medical outcome data 112 and health grades data 114 as pertaining to the search criteria by parsing the contents of tags 120, 122, 124, 124. In this example, which is independent of link 128, data engine 105 compares the contents of tags 120, 122, 124, 124 to the search criteria of “knee surgeries performed at Mount Vernon hospital.” Based on the comparison, data engine 105 identifies values of the medical facility name and medical procedure name attributes for medical outcome data 112 and health grades data 114 as matching the search criteria. Accordingly, data engine 105 generates cross-channel medical data 132 including medical outcome data 112 and health grades data 114 as responsive to the search request.

In another example, data engine 105 generates another item of cross-channel medical data (not shown) from numerous items of medical outcome data (and/or any other type of data, including, e.g., health grades data, EHR data, billing data, or any combination thereof) pertaining to knee surgeries performed at Mount Vernon hospital. In this example, this item of cross-channel medical data includes a comparison of the different items of data for a particular type of data, including, e.g., medical outcome data, health grades data, EHR data, and billing data. For example, for medical outcome data, data engine 105 may be configured to generate data indicative of a number (e.g., a percentage and/or an absolute number) of knee surgeries performed at Mount Vernon hospital that have been successful procedures or failing procedures. In still another example, the cross-channel medical information may be based on numerous items of billing data. In this example, the cross-channel medical information may include an average cost for knee surgeries performed at Mount Vernon hospital.

In still another example, data engine 105 receives another, different request (not shown) for data pertaining to different search criteria, namely, a patient named “Winston Madison.” Data engine 105 is configured to identify EHR data 116 and billing data 118 as pertaining to a patient named Winston Madison, e.g., based on a comparison of the search criteria to values of the patient name attributes included in tags 120, 122, 124, 126, the contents of which are shown in the foregoing Tables 2-5. In response to the request for data pertaining to the patient named Winston Madison, data engine 105 generates cross-channel medical data 134. Cross-channel medical data 134 includes EHR data 116 and billing data 118. In an example, cross-channel medical data 134 includes a graphical user interface that renders a visual representation of the contents of EHR data 116 and billing data 118.

In still another example, data engine 105 may be configured to generate cross-channel medical data that includes medical outcome data 112, health grades data 114, EHR data 116, and billing data 118, for example, in response to a search for data pertaining to Mount Vernon hospital. In this example, data engine 105 compares the search criteria of “Mount Vernon hospital” to the values of the medical facility name attribute included in tags 120, 122, 124, 126. Based on the comparison, data engine 105 determines that medical outcome data 112, health grades data 114, EHR data 116, and billing data 118 all pertain to Mount Vernon hospital.

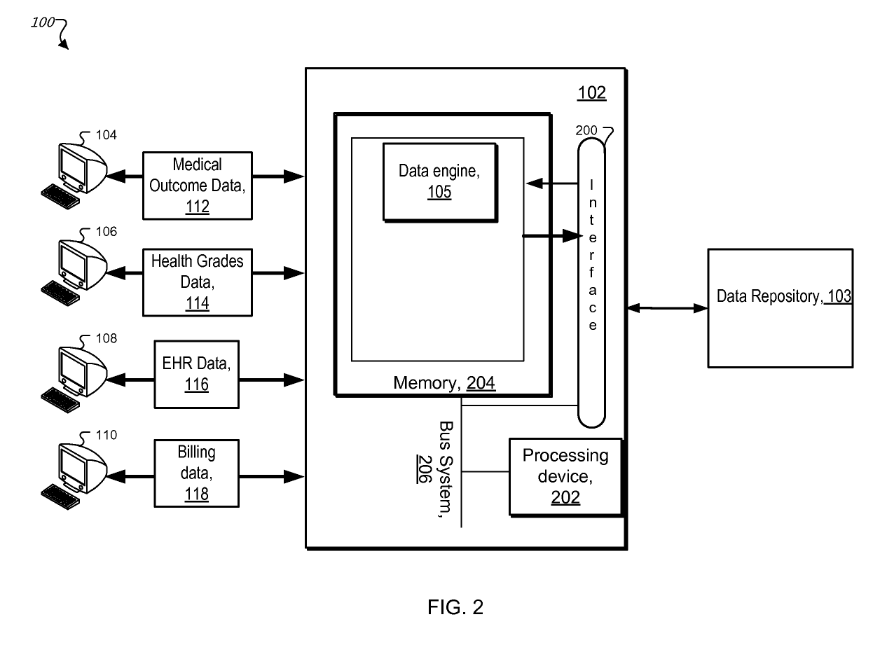

FIG. 2 illustrates a particular exemplary embodiment describe herein. FIG. 2 is a block diagram of components of system 100 for generating cross-channel medical data 132, 134. In FIG. 2, cross-channel medical data 132, 134 and the contents of data repository 103 (namely, tags 120, 122, 124, 126 and procedure name links 128, 130) are not shown.

Client devices 104, 106, 108, 110 can be any sort of computing devices capable of taking input from a user and communicating over a network (not shown) with server 102 and/or with other client devices. For example, client devices 104, 106, 108, 110 can be mobile devices, medical devices, desktop computers, laptops, cell phones, personal digital assistants (“PDAs”), servers, embedded computing systems, and so forth.

In the exemplary embodiment of FIG. 2, server 102 can be any of a variety of computing devices capable of receiving data, such as a server, a distributed computing system, a desktop computer, a laptop, a cell phone, a rack-mounted server, a mobile device, a medical device, and so forth. Server 102 may be a single server or a group of servers that are at a same location or at different locations.

The illustrated server 102 can receive data from client devices 104, 106, 108, 110 via input/output (“I/O”) interface 200. I/O interface 200 can be any type of interface capable of receiving data over a network, such as an Ethernet interface, a wireless networking interface, a fiber-optic networking interface, a modem, and so forth. Server 102 also includes a processing device 202 and memory 204. A bus system 206, including, for example, a data bus and a motherboard, can be used to establish and to control data communication between the components of server 102.

The illustrated processing device 202 may include one or more microprocessors. Generally, processing device 202 may include any appropriate processor and/or logic that is capable of receiving and storing data, and of communicating over a network (not shown). Memory 204 can include a hard drive and a random access memory storage device, such as a dynamic random access memory, or other types of non-transitory machine-readable storage devices. As shown in FIG. 2, memory 204 stores computer programs that are executable by processing device 202. Among these computer programs is data engine 105.

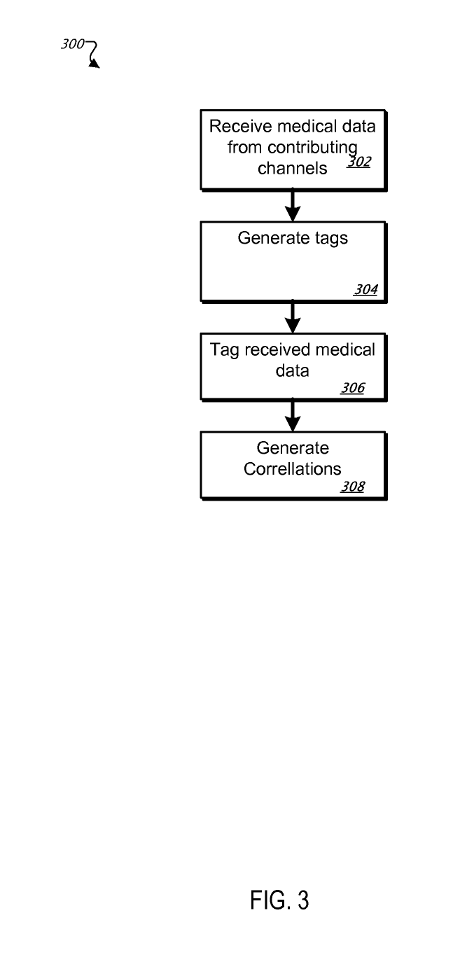

FIG. 3 illustrates a particular exemplary embodiment describe herein. In particular, FIG. 3 is a flow chart of process 300 for correlating medical data received from contributing channels. In operation, data engine 105 receives (302), from various, different contributing channels, medical data, including, e.g., medical outcome data 112, health grades data 114, EHR data 116, and billing data 118. Data engine 105 generates (304) tags 120, 122, 124, 126 for received data 112, 114, 116, 118, e.g., by generating metadata indicative of attributes of received data 112, 114, 116, 118, as illustrated in the foregoing Tables 2-5. Data engine 105 also tags (306) received data 112, 114, 116, 118, for example, by associating tags 120, 122, 124, 126 with medical outcome data 112, health grades data 114, EHR data 116, and billing data 118, respectively.

In an exemplary embodiment described herein, data engine 105 also generates (308) correlations 128, 130 (FIG. 1) among received data 112, 114, 116, 118, e.g., based on a similarity and/or a sameness of values for metadata included in tags 120, 122, 124, 126. In an example, the generated correlations include links 128, 130.

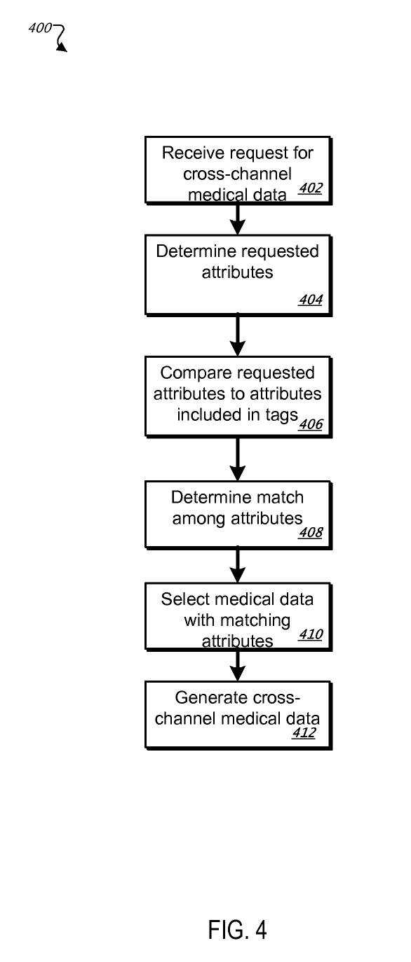

FIG. 4 illustrates a particular exemplary embodiment describe herein. In particular, FIG. 4 is a flow chart of process 400 for generating cross-channel medical data. In operation, data engine 105 receives (402) a request for cross-channel medical data, e.g., from a computing device used by a data consumer. In response, data engine 105 determines (404) requested attributes (e.g., search criteria) for the cross-channel medical data, e.g., by parsing contents of the request.

Data engine 105 accesses data repository 103 and compares (406) the requested attributes to value of attributes included in tags 120, 122, 124, 126, e.g., as specified by the metadata included in the foregoing tags. Data engine 105 determines (408) a match and/or correspondence among one or more of the requested attributes and values of the attributes included in tags 120, 122, 124, 126. Data engine 105 selects (410) medical data with attributes matching the requested attributes. Using the selected medical data, data engine 105 generates (412) cross-channel medical data, including, e.g., cross-channel medical data 132, 134.

Using the techniques described herein, medical data is collected from numerous, different contributing channels and tagged with metadata indicative of attributes of the medical data. Additionally, cross-channel medical data is generated, e.g., by collecting together medical data associated with same and/or similar attributes and/or attributes meeting various requested attributes.

As used herein, the terms “computer” and “computer systems” refer broadly to any sort of combination of one or more servers and/or computing devices. As used herein, the terms “instrument(s)” and “medical study instrument(s)” refer broadly to any type of device and/or document (or any combination thereof), which presents data and/or data to a user and allows the user to input and/or send data and/or data to the system 102

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be data in different formats such as text, graphics, images, sound, video, Hypertext Markup Language (HTML), as well as programs. Upon specification of a link by the user, the client computer makes a TCP/IP request to a Web server and receives data, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view data available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.”

A number of exemplary embodiments of the invention have been described. Nevertheless, it will be understood by one of ordinary skill in the art that various modifications may be made without departing from the spirit and scope of the invention.

What is claimed is:

1. A computer-implemented method comprising:
receiving, by one or more computers through one or more contributing channels, a plurality of items of medical data;
generating, for the received medical data, one or more tags comprising metadata indicative of one or more attributes of the received medical data; and
generating, at least partly based on the one or more tags, a correlation between at least a first item of medical data from the plurality and a second, different item of medical data from the plurality.

2. The computer-implemented method of claim 1, further comprising:
comparing a first value of a first attribute for the first item of medical data to a second value of a second attribute for the second item of medical data; and
determining, based on comparing, a correspondence between the first value and the second value.

3. The computer-implemented method of claim 2, wherein the correlation includes at least metadata indicative of one or more of (i) the first value of the first attribute, or (ii) the second value of the second attribute.

4. The computer-implemented method of claim 1, further comprising:
receiving a request for cross-channel medical data received from numerous, different contributing channels;
parsing the request to determine one or more requested attributes for the cross-channel medical data;
comparing attributes included in the tagged medical data to the one or more requested attributes;
identifying, based on comparing, the first item of medical data and the second item of medical data as comprising attributes matching the requested attributes; and
generating, using the identified first item of medical data and the identified second item of medical data, the cross-channel medical data.

5. The computer-implemented method of claim 1, further comprising:
receiving a request for cross-channel medical data received from numerous, different contributing channels;
parsing the request to determine one or more attributes of the cross-channel medical data;
identifying a correspondence between (i) at least one of the one or more requested attributes, and (ii) metadata associated with the correlation; and
generating, at least partly based on the first item of medical data and the second item of medical data, the cross-channel medical data.

6. The computer-implemented method of claim 5, further comprising:
generating a graphical user interface that when rendered on a display device renders a visual representation of the cross-channel medical data.

7. One or more machine-readable media configured to store instructions that are executable by one or more processing devices to perform operations comprising:
receiving, through one or more contributing channels, a plurality of items of medical data;
generating, for the received medical data, one or more tags comprising metadata indicative of one or more attributes of the received medical data; and
generating, at least partly based on the one or more tags, a correlation between at least a first item of medical data from the plurality and a second, different item of medical data from the plurality.

8. The one or more machine-readable media of claim 7, wherein the operations comprise:
comparing a first value of a first attribute for the first item of medical data to a second value of a second attribute for the second item of medical data; and determining, based on comparing, a correspondence between the first value and the second value.

9. The one or more machine-readable media of claim 8, wherein the correlation includes at least metadata indicative of one or more of (i) the first value of the first attribute, or (ii) the second value of the second attribute.

10. The one or more machine-readable media of claim 7, wherein the operations comprise:
receiving a request for cross-channel medical data received from numerous, different contributing channels;
parsing the request to determine one or more requested attributes for the cross-channel medical data;
comparing attributes included in the tagged medical data to the one or more requested attributes;
identifying, based on comparing, the first item of medical data and the second item of medical data as comprising attributes matching the requested attributes; and
generating, using the identified first item of medical data and the identified second item of medical data, the cross-channel medical data.

11. The one or more machine-readable media of claim 7, wherein the operations comprise:
receiving a request for cross-channel medical data received from numerous, different contributing channels;
parsing the request to determine one or more attributes of the cross-channel medical data;
identifying a correspondence between (i) at least one of the one or more requested attributes, and (ii) metadata associated with the correlation; and
generating, at least partly based on the first item of medical data and the second item of medical data, the cross-channel medical data.

12. The one or more machine-readable media of claim 11, wherein the operations comprise:
generating a graphical user interface that when rendered on a display device renders a visual representation of the cross-channel medical data.

13. An electronic system comprising:
one or more processing devices; and
one or more machine-readable media configured to store instructions that are executable by the one or more processing devices to perform operations comprising:
receiving, through one or more contributing channels, a plurality of items of medical data;
generating, for the received medical data, one or more tags comprising metadata indicative of one or more attributes of the received medical data; and
generating, at least partly based on the one or more tags, a correlation between at least a first item of medical data from the plurality and a second, different item of medical data from the plurality.

14. The electronic system of claim 13, wherein the operations comprise:
comparing a first value of a first attribute for the first item of medical data to a second value of a second attribute for the second item of medical data; and
determining, based on comparing, a correspondence between the first value and the second value.

15. The electronic system of claim 14, wherein the correlation includes at least metadata indicative of one or more of (i) the first value of the first attribute, or (ii) the second value of the second attribute.

16. The electronic system of claim 13, wherein the operations comprise:
receiving a request for cross-channel medical data received from numerous, different contributing channels;
parsing the request to determine one or more requested attributes for the cross-channel medical data;
comparing attributes included in the tagged medical data to the one or more requested attributes;
identifying, based on comparing, the first item of medical data and the second item of medical data as comprising attributes matching the requested attributes; and
generating, using the identified first item of medical data and the identified second item of medical data, the cross-channel medical data.

17. The electronic system of claim 13, wherein the operations comprise:
receiving a request for cross-channel medical data received from numerous, different contributing channels;
parsing the request to determine one or more attributes of the cross-channel medical data;
identifying a correspondence between (i) at least one of the one or more requested attributes, and (ii) metadata associated with the correlation; and
generating, at least partly based on the first item of medical data and the second item of medical data, the cross-channel medical data.

18. The electronic system of claim 17, wherein the operations comprise:
generating a graphical user interface that when rendered on a display device renders a visual representation of the cross-channel medical data.
